(19) United States
(12) Patent Application Publication
(10) Pub. No.: US 2025/0167701 A1
(43) Pub. Date: May 22, 2025

(54) METHOD FOR SUPPRESSING DC BUS VOLATGE RESONANCE CAUSED BY FILM CAPACITOR OF PERMANENT MAGNET SYNCHRONOUS MOTOR

(71) Applicant: Broad-Ocean Motor (Wuhan) Research Institute Co., Ltd., Wuhan (CN)

(72) Inventors: Fei YANG, Wuhan (CN); Zhejiang LIU, Wuhan (CN); Song LUO, Wuhan (CN); Yuhang WANG, Wuhan (CN)

(21) Appl. No.: 19/023,188

(22) Filed: Jan. 15, 2025

Related U.S. Application Data
(63) Continuation-in-part of application No. PCT/CN2024/081044, filed on Mar. 11, 2024.

(30) Foreign Application Priority Data
Aug. 29, 2023 (CN) 202311093527.9

(51) Int. Cl. H02P 21/05; H02P 21/22

(52) U.S. Cl. CPC H02P 21/05; H02P 21/22; H02P 2207/05

(57) ABSTRACT

A method for reducing DC bus voltage fluctuations caused by a film capacitor in a permanent magnet synchronous motor, including: sampling, using a voltage sensing circuit, a total DC bus voltage (U_{dc}) from an inverter in real-time; passing the total DC bus voltage (U_{dc}) through a low-pass filter to extract a DC component (U_{dc0}) of the total DC bus voltage; obtaining an AC component (Tₑ=P₀·ψ_{f}×i_{q} - - - (1)) of the total DC bus voltage (U_{dc}) by subtracting the DC component (U_{dc0}) from the total DC bus voltage (U_{dc}): ũ_{dc}=U_{dc}−U_{dc0}; obtaining a reference DC bus voltage (u*_{dc}) by subtracting the AC component (Tₑ=P₀·ψ_{f}×i_{q} - - - (1)) from the DC component (U_{dc0}): u*_{dc}=U_{dc0}−Tₑ=P₀·ψ_{f}×i_{q}- - - (1); and passing the reference DC bus voltage (u*_{dc}) to a space vector pulse width modulation (SVPWM) module, thereby performing calculations that generate precise switching signals for the inverter.

### CROSS-REFERENCE TO RELATED APPLICATIONS

This application is a continuation-in-part of International Patent Application No. PCT/CN2024/081044 with an international filing date of Mar. 11, 2024, designating the United States, now pending, further claims foreign priority benefits to Chinese Patent Application No. 202311093527.9 filed Aug. 29, 2023. The contents of all of the aforementioned applications, including any intervening amendments thereto, are incorporated herein by reference.

### BACKGROUND

The disclosure relates to a method for suppressing DC bus voltage resonance caused by a film capacitor of a permanent magnet synchronous motor.

A permanent magnet synchronous motor (PMSM) is often controlled using a control strategy known as field-oriented control (FOC), which is also referred to as vector control (VC). The control strategy precisely manage both the magnitude and direction of the magnetic field generated by the PMSM, thereby ensuring smooth operation, low noise, and quick responses of the PMSM.

As shown in FIGS. 1-3, a PMSM typically includes a motor unit 1 and a motor controller 2. The motor unit 1 includes a stator assembly 12, a rotor assembly 13, and a housing assembly 11. The stator assembly 12 includes a stator core and windings. The windings are wrapped around the stator core. The stator assembly 12 is mounted on the housing assembly 11. The rotor assembly 13 is mounted inside the stator assembly 12. The motor controller 2 includes a control box 22 and a control circuit board 21. The control circuit board 21 is mounted inside the control box 22. A plurality of electrolytic capacitors are mounted on the control circuit board 21 to function as DC bus capacitors 23, as shown in FIG. 2.

A conventional motor controller typically uses electrolytic capacitors as the DC bus capacitors, with capacitance values in the hundreds of microfarads. The electrolytic capacitors help stabilize the dc bus voltage and absorb energy during the deceleration phase of the motor operation. However, the electrolytic capacitors have drawbacks, including short operation lifespan, large physical size, and high cost. To address the issues, film capacitors are used as an alternative to the electrolytic capacitor. The film capacitors have lower capacitors, usually in the range of tens of microhenries. The lower capacitance values increase the risk of overvoltage, leading to failures in the power electronics components of the motor drive.

A conventional method is to integrate film capacitors into the DC bus to suppress overvoltage in PMSMs. However, the presence of an LC circuit within a control circuit affect the performance of the PMSMs. The LC circuit is an LC oscillation that is formed by the inductor (L) from the DC filtering circuit and a DC bus film capacitor (B5). As shown in FIG. 4, the inductor and the DC bus film capacitor create a resonant circuit, which can introduce harmonic voltage fluctuations across the DC bus film capacitor. The harmonic voltage fluctuations impact the precision and efficiency of the PMSMs. As shown in FIG. 4, the PMSM includes a motor unit (B7) and a motor controller. The motor unit includes a stator assembly and a permanent magnet rotor assembly. The stator assembly includes a stator core and windings. The windings are wrapped around the stator core. The motor controller includes an AC filtering circuit (B2), a rectifying circuit (B3), a DC filtering circuit (B4), the DC bus film capacitor (B5), an inverter circuit (B6), a microcontroller unit (MCU), and a phase current detection circuit. A three-phase AC power supply (B1) passes through the AC filtering circuit (B2), then the rectifying circuit (B3), and finally the DC filtering circuit (B4) to charge the DC bus film capacitor (B5). The DC bus film capacitor provides high-voltage DC power to the inverter circuit (B6). The phase current detection circuit continuously monitors the current flowing through the windings and provides real-time feedback on the current in each phase to a microcontroller unit (MCU). The MCU uses the real-time feedback to make precise adjustments to the operation of the inverter circuit. The inverter circuit then switches the windings on and off at the right times. The operation of the PMSM is governed by the FOC. The FOC is well-documented in textbooks and online resources, and thus not described in detail herein.

Harmonic voltage fluctuations caused by the LC circuit disrupts the control and efficiency of the PMSM. To address the issues, a strategy for suppressing voltage resonance is often employed, as shown in FIG. 5. The strategy involves injecting voltage into the dq-axis. Specifically, the strategy involves: measuring a total DC bus voltage (U_{dc}) from an inverter in real-time; passing the total DC bus voltage (U_{dc}) through a low-pass filter to extract a DC component (U_{dc0}) of the total DC bus voltage; subtracting the DC component (U_{dc0}) from the total DC bus voltage (U_{dc}) to obtain an AC component (Tₑ=P₀·ψ_{f}×i_{q} - - - (1)) of the total DC bus voltage (U_{dc}); multiplying the AC component by two predefined coefficients, kd and kq, to obtain an adjusted AC component; and adding the adjusted AC component to the dq-axis voltage to suppress LC oscillations generated by the LC circuit.

The primary issues with the strategy for suppressing voltage resonance are as follows: 1. The motors with different power ratings or those operating under varying load conditions require re-tuning of the coefficients k_{d} and k_{q} to achieve optimal resonance suppression. 2. The injection of the dq-axis voltage for resonance suppression introduces high-frequency ripple currents into a motor control system. The high-frequency ripple currents degrade the overall performance of the motor, resulting in increased acoustic noise.

As shown in FIGS. 5 and 6, to suppress the LC oscillations, a drive system uses the film capacitors to replace the conventional electrolytic capacitors. The shift reduces the capacitance to roughly 1/50 of the original value of the conventional electrolytic capacitors. The smaller-capacitance film capacitors are directly related to a low energy storage capacity. Consequently, when the three-phase AC power is rectified by a bridge rectifier, a ripple at six times the main frequency is introduced onto the DC bus voltage. Additionally, the LC oscillations become superimposed onto the DC bus voltage. To prevent high-frequency harmonic feedback from entering the power grid, the motor control system typically incorporates a DC reactor. The DC reactor, in combination with the DC bus film capacitor, forms the LC oscillations. The LC oscillations increases with the increasing of the operating power of the motor.

As shown in FIG. 6, using a simplified model, the state equations of the motor control system are described as follows:

$$\{ \begin{matrix}{L}_{dc} \frac{{di}_{g}}{dt} = {u}_{s} - {R}_{dc} {i}_{g} - {u}_{dc} \\ {C}_{dc} \frac{{du}_{dc}}{dt} = {i}_{g} - {i}_{inv}\end{matrix}$$

The inverter and the motor control system exhibit a constant power load characteristic, meaning that the average output power of the inverter is equal to the average power consumed by the motor, assuming switching losses are negligible. The average current output of the inverter can be expressed as follows:

$${i}_{inv} = \frac{{P}_{L}}{{u}_{dc}} = \frac{{P}_{L}}{{u}_{dc 0} + {\tilde{u}}_{dc}}$$

Because the fluctuations in the DC bus voltage are small, the average output current of the inverter can be linearized as follows:

$$\begin{matrix}{i}_{inv} = \frac{{P}_{L} ( {u}_{dc 0} - {\tilde{u}}_{dc} )}{( {u}_{dc 0} + {\tilde{u}}_{dc} ) \times ( {u}_{dc 0} - {\tilde{u}}_{dc} )} \\ = \frac{{P}_{L} ( {u}_{dc 0} - {\tilde{u}}_{dc} )}{{u}_{dc 0}^{2} - {\tilde{u}}_{dc}^{2}} \\ = \frac{{P}_{L}}{{u}_{dc 0}} - \frac{{P}_{L}}{{u}_{dc 0}^{2}} {\tilde{u}}_{dc}\end{matrix}$$

The average output current of the inverter iᵢₙᵥ is inserted into the state equation of the motor control system, and a Laplace transform is performed to derive the following characteristic equation of the motor control system:

$${s}^{2} + ( \frac{{R}_{dc}}{{L}_{dc}} - \frac{{P}_{L}}{{C}_{dc} {u}_{dc 0}^{2}} ) s + \frac{1}{{L}_{dc} {C}_{dc}} ( 1 - \frac{{R}_{dc} {P}_{L}}{{u}_{dc}^{2}} ) = 0$$

Using the Routh stability criterion, the stability of the motor control system is determined by the coefficients of the characteristic equation. For the motor control system to be stable, all the coefficients must be positive. Specifically, the third coefficient is usually positive. Therefore, the stability of the motor control system is primarily influenced by the second coefficient. For the motor control system to remain stable, the coefficients in the characteristic equation meets the following conditions:

$${C}_{dc} > \frac{{L}_{dc} {P}_{L}}{{R}_{dc} {u}_{dc 0}^{2}}$$

When operating at higher power levels, the dynamics of the motor drive system change, and the demands on energy storage increase. If the film capacitors with small capacitances are insufficient to manage the demands, the motor control system becomes unstable. Therefore, it is critical to improve the stability of the motor drive system without the electrolytic capacitors.

### SUMMARY

To solve the aforesaid problems, the disclosure provides a method for suppressing DC bus voltage resonance caused by a film capacitor of a permanent magnet synchronous motor.

The permanent magnet synchronous motor adopts a (field oriented control) FOC strategy, and the method comprises:
S1. sampling, using a voltage sensing circuit, a total DC bus voltage (U_{dc}) from an inverter in real-time;
S2. passing the total DC bus voltage (U_{dc}) through a low-pass filter to extract a DC component (U_{dc0}) of the total DC bus voltage;
S3. obtaining an AC component (Tₑ=P₀·ψ_{f}×i_{q} - - - (1)) of the total DC bus voltage (U_{dc}) by subtracting the DC component (U_{dc0}) from the total DC bus voltage (U_{dc}): ũ_{dc}=U_{dc}−U_{dc0};
S4. obtaining a reference DC bus voltage (u*_{dc}) by subtracting the AC component (Tₑ=P₀·ψ_{f}×i_{q} - - - (1)) from the DC component (U_{dc0}): u*_{dc}=U_{dc0}−Tₑ=P₀·ψ_{f}×i_{q}- - - (1); and
S5. passing the reference DC bus voltage (u*_{dc}) to a space vector pulse width modulation (SVPWM) module, thereby performing calculations that generate precise switching signals for the inverter.

In a class of this embodiment, the DC component (U_{dc0}) is calculated using the formula:

$${u}_{dc 0} ( n ) = {qu}_{dc} ( n ) + ( 1 - q ) {u}_{dc 0} ( n - 1 )$$

where, q is a coefficient of the low-pass filter; n is the number of times the voltage sensing circuit samples the total DC bus voltage (U_{dc});

In a class of this embodiment, a sampling frequency of the total bus voltage (Udc) is in sync with a carrier frequency of the SVPWM module.

The following advantages are associated with the disclosed method.

1. LC resonance suppression and reduced DC bus voltage fluctuations: The electrolytic capacitors (which have capacitance in the hundreds of microfarads) are often replaced with the film capacitors in the tens of microhenries, so that the motor circuit may experience voltage oscillations. The voltage oscillations arise from rectification ripple and LC resonance. At 300 Hz, the rectification ripple is a byproduct of the AC-to-AC conversion process in the rectifier bridge. The LC resonance occurs due to the interaction of the film capacitors on the DC bus and a differential-mode inductor. The rectification ripple remains consistent, regardless of the motor power, but the LC resonance becomes more pronounced as the motor power increases. Therefore, suppressing the LC resonance is essential for maintaining a stable DC bus voltage, particularly at higher motor power levels.

2. By implementing the LC resonance suppression, the fluctuations on the DC bus voltage are minimized, leaving only the consistent 300 Hz rectification ripple. The stability translates to smoother operation within the motor control system, leading to reduced Total Harmonic Distortion (THD) in the motor's phase current.

3. By implementing the LC resonance suppression, the fluctuations on the DC bus voltage are minimized, and the motor control system operates more reliably. The stability directly reduces the THD in the grid-side input current.

### BRIEF DESCRIPTION OF THE DRAWINGS

FIG. 1 is a perspective view of a conventional permanent magnet synchronous motor;

FIG. 2 is a perspective view of a motor controller of a conventional permanent magnet synchronous motor;

FIG. 3 is a sectional view of a conventional permanent magnet synchronous motor;

FIG. 4 is a block diagram of a circuit for a motor controller of a conventional permanent magnet synchronous motor;

FIG. 5 is a block diagram showing the principle of injecting voltage in dq-axis for suppressing LC resonance in a conventional permanent magnet synchronous motor;

FIG. 6 is an equivalent circuit diagram for a conventional permanent magnet synchronous motor;

FIG. 7 is a block diagram showing the principle of suppressing LC o in a permanent magnet synchronous motor according to one example of the disclosure;

FIG. 8 is a flowchart for suppressing LC resonance in a permanent magnet synchronous motor according to one example of the disclosure;

FIG. 9 shows simulation results of DC bus fluctuations when LC resonance suppression algorithm is not applied for a film capacitor of a motor drive system;

FIG. 10 shows FFT analysis when LC resonance suppression algorithm is not applied for a film capacitor of a motor drive system;

FIG. 11 shows simulation results of DC bus fluctuations when LC resonance suppression algorithm is applied for a film capacitor of a motor drive system;

FIG. 12 shows FFT analysis of DC bus fluctuations when LC resonance suppression algorithm is applied for a film capacitor of a motor drive system;

FIG. 13 shows experimental results of DC bus fluctuations when LC resonance suppression algorithm is not applied for a film capacitor of a motor drive system;

FIGS. 14A-14C show FFT analysis of DC bus voltage, phase current, and grid-side input current when LC resonance suppression algorithm is not applied for a film capacitor of a motor drive system;

FIG. 15 shows experimental results of DC bus fluctuations when LC resonance suppression algorithm is applied for a film capacitor of a motor drive system; and

FIGS. 16A-16C show FFT analysis of DC bus voltage, phase current, and grid-side input current when LC resonance suppression algorithm is applied for a film capacitor of a motor drive system.

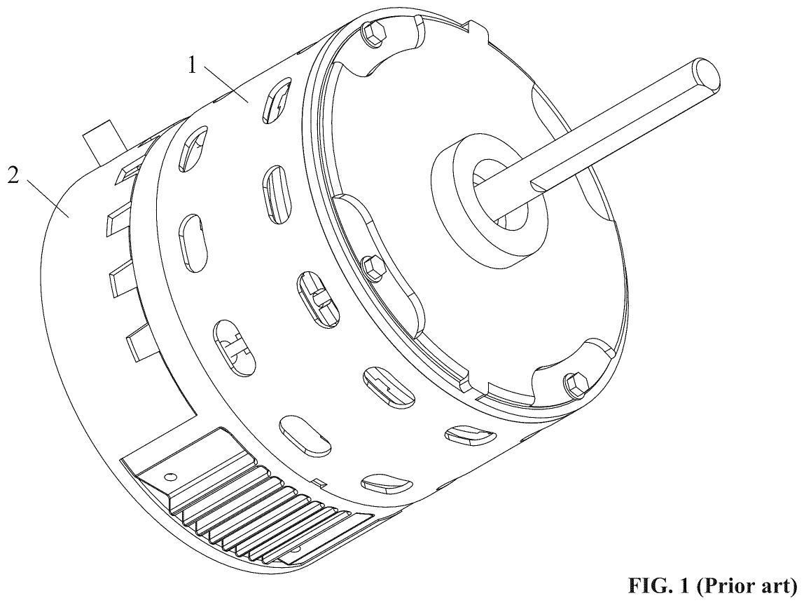

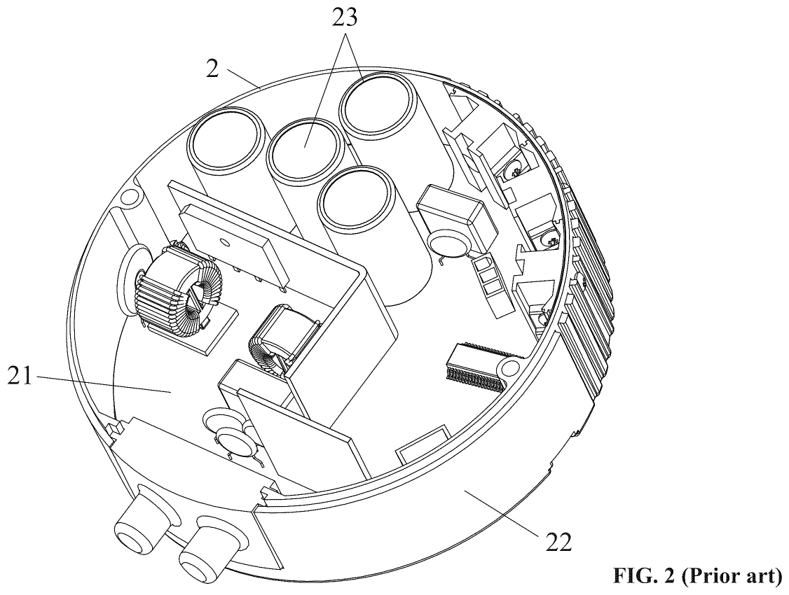

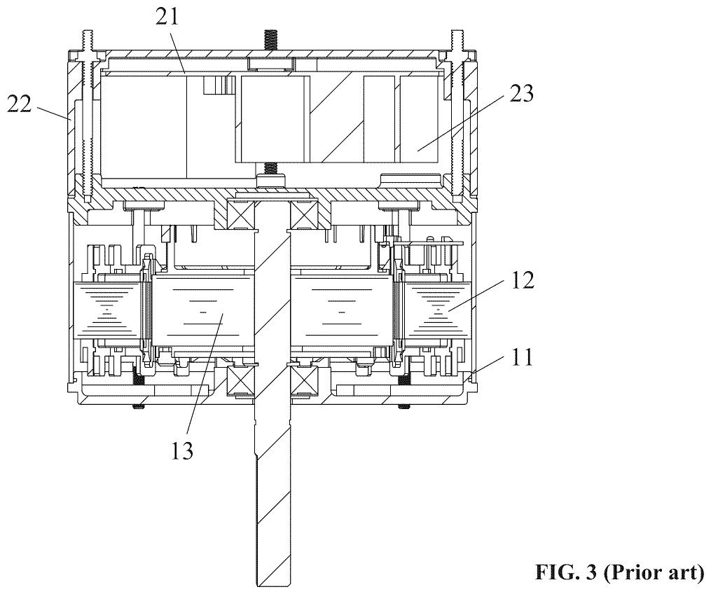

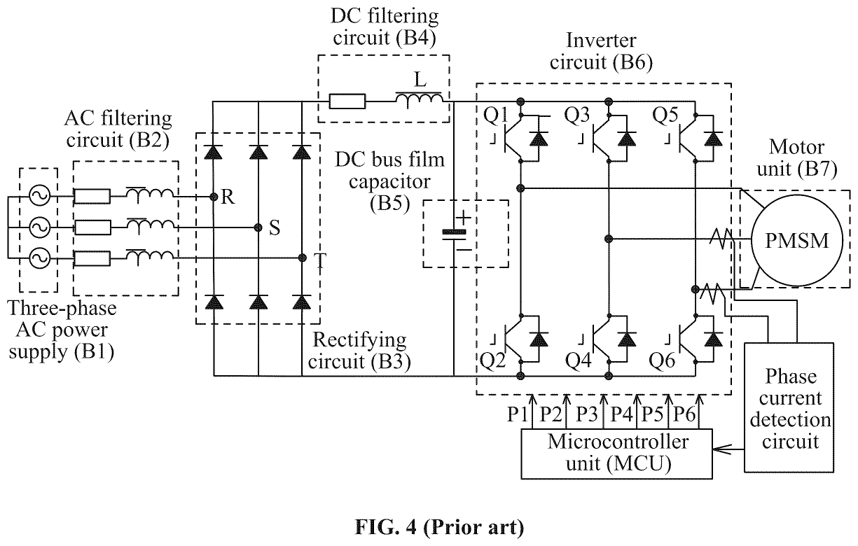

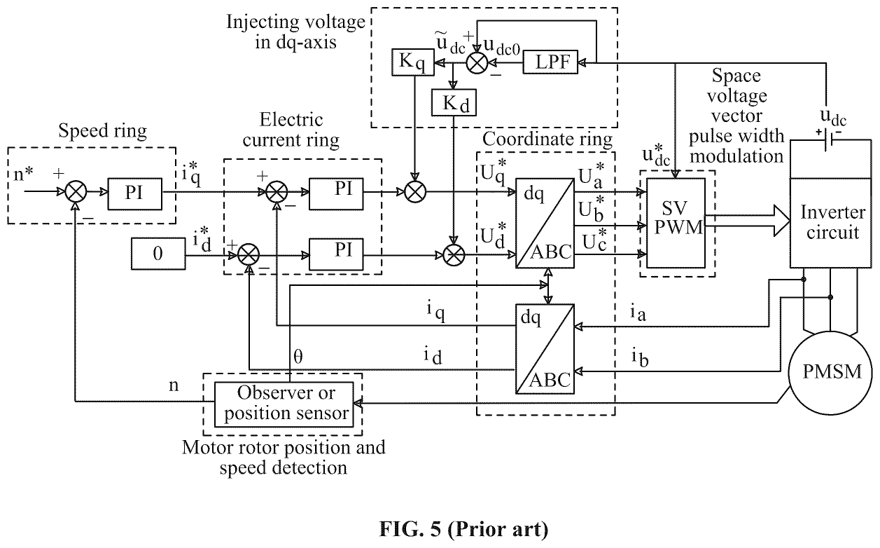

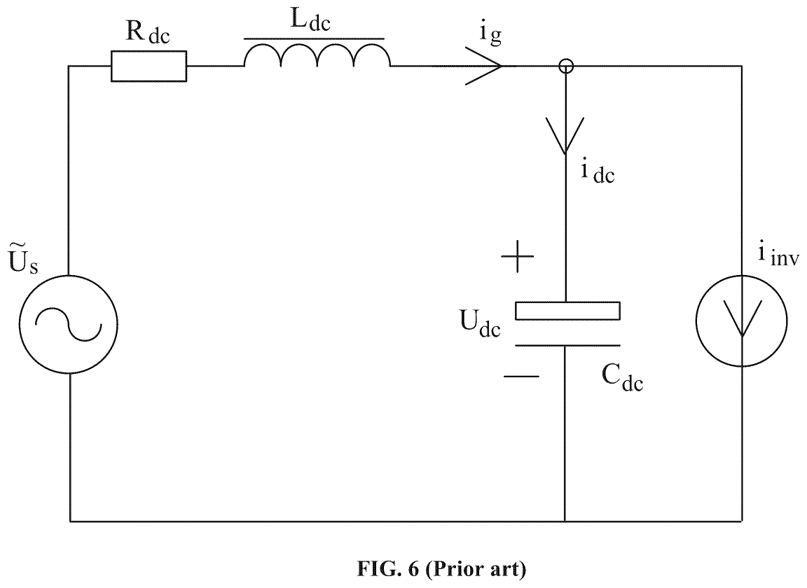

### DETAILED DESCRIPTION

To further illustrate the disclosure, embodiments detailing the method for suppressing DC bus voltage resonance caused by a film capacitor of a permanent magnet synchronous motor are described below. It should be noted that the following embodiments are intended to describe and not to limit the disclosure.

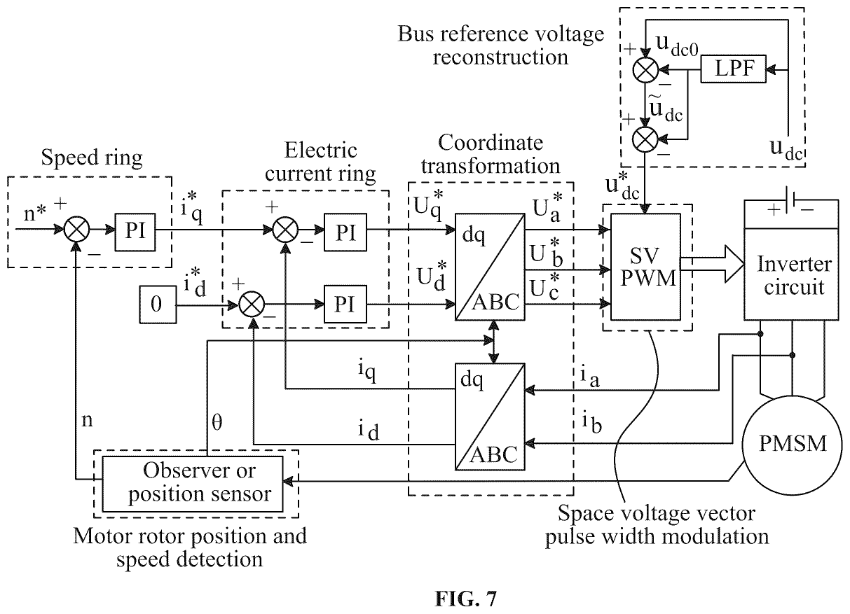

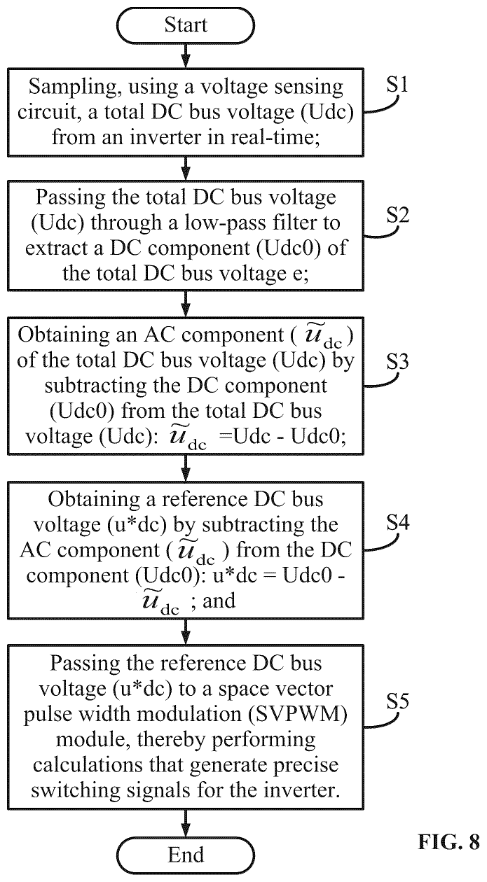

As shown in FIGS. 7 and 8, the permanent magnet synchronous motor adopting a (field-oriented control) FOC strategy. Specifically, the method comprises:
S1. sampling, using a voltage sensing circuit, a total DC bus voltage (U_{dc}) from an inverter in real-time;
S2. passing the total DC bus voltage (U_{dc}) through a low-pass filter to extract a DC component (U_{dc0}) of the total DC bus voltage e;
S3. obtaining an AC component (Tₑ=P₀·ψ_{f}×i_{q} - - - (1)) of the total DC bus voltage (U_{dc}) by subtracting the DC component (U_{dc0}) from the total DC bus voltage (U_{dc}): ũ_{dc}=U_{dc}−U_{dc0};
S4. obtaining a reference DC bus voltage (u*_{dc}) by subtracting the AC component (Tₑ=P₀·ψ_{f}×i_{q} - - - (1)) from the DC component (U_{dc0}): u*_{dc}=U_{dc0}−Tₑ=P₀·ψ_{f}×i_{q}- - - (1); and
S5. passing the reference DC bus voltage (u*_{dc}) to a space vector pulse width modulation (SVPWM) module, thereby performing calculations that generate precise switching signals for the inverter.

In certain embodiments, the DC component (U_{dc0}) is calculated using the formula:

$${u}_{dc 0} ( n ) = {qu}_{dc} ( n ) + ( 1 - q ) {u}_{dc 0} ( n - 1 )$$

where, q is a coefficient of the low-pass filter; n is the number of times the voltage sensing circuit samples the total DC bus voltage (U_{dc}).

In certain embodiments, a sampling frequency of the total bus voltage (U_{dc}) is in sync with a carrier frequency of the SVPWM module.

The method enhances the stability of the motor control system by modifying the reference DC bus voltage (u*_{dc}) used within the SVPWM module. The modification adjusts the output voltage in a way that suppresses LC oscillation, keeping the DC bus voltage more stable, thereby maintaining reliable operation as motor power increases.

The working principle of the method is described as follows:

The motor output power is calculated using the formula:

$${P}_{L} = {\overline{u}}_{abc} \cdot {\overline{ι}}_{abc}$$

Typically, in an SVPWM algorithm, the sampled total DC bus voltage is used as the reference DC bus voltage for controlling the motor:

$${u}_{dc}^{*} = {u}_{dc} = {u}_{dc 0} + {\tilde{u}}_{dc}$$

In the method, the sampled total DC bus voltage is not used directly. Instead, the sampled total DC bus voltage is reconstructed to provide a reference DC bus voltage. The reference DC bus voltage is then used to calculate an output voltage vector within the SVPWM algorithm. The reference DC bus voltage is expressed as follows:

$${u}_{dc}^{*} = {u}_{dc 0} - {\tilde{u}}_{dc}$$

The output voltage vector is calculated using the formula:

$${\overline{u}}_{abc \_ rec} = \frac{{\overline{u}}_{abc}}{{u}_{dc}^{*}} {u}_{dc} = {\overline{u}}_{abc} \frac{{u}_{dc 0} + {\tilde{u}}_{dc}}{{u}_{dc 0} - {\tilde{u}}_{dc}}$$

An actual operating power of the motor is expressed as follows:

$${P}_{L \_ rec} = {\overline{u}}_{abc \_ rec} \cdot {\overline{ι}}_{abc} = {\overline{u}}_{abc} \frac{{u}_{dc 0} + {\tilde{u}}_{dc}}{{u}_{dc 0} - {\tilde{u}}_{dc}} \cdot {\overline{ι}}_{abc} = {P}_{L} \frac{{u}_{dc 0} + {\tilde{u}}_{dc}}{{u}_{dc 0} - {\tilde{u}}_{dc}}$$

An average output current of the inverter is calculated through formula:

$$\begin{matrix}{i}_{inv} = \frac{{P}_{L \_ rec}}{{u}_{dc}} \\ = \frac{{P}_{L} \frac{{u}_{dc 0} + {\tilde{u}}_{dc}}{{u}_{dc 0} - {\tilde{u}}_{dc}}}{{u}_{dc 0} + {\tilde{u}}_{dc}} \\ = \frac{{P}_{L}}{{u}_{dc 0} - {\tilde{u}}_{dc}} \\ = \frac{{P}_{L} ( {u}_{dc 0} + {\tilde{u}}_{dc} )}{{u}_{dc 0}^{2} - {\tilde{u}}_{dc}^{2}} \\ \approx \frac{{P}_{L}}{{u}_{dc 0}} + \frac{{P}_{L}}{{u}_{dc 0}^{2}} {\tilde{u}}_{dc}\end{matrix}$$

The average output current of the inverter is substituted into the state equation of the motor control system, and a Laplace transform is performed to derive a new system characteristic equation of the motor control system:

$${s}^{2} + ( \frac{{R}_{dc}}{{L}_{dc}} + \frac{{P}_{L}}{{C}_{dc} {u}_{dc 0}^{2}} ) s + \frac{1}{{L}_{dc} {C}_{dc}} ( 1 + \frac{{R}_{dc} {P}_{L}}{{u}_{dc}^{2}} ) = 0$$

From analyzing the new characteristic equation, it is obvious that all coefficients are positive constants. The positivity indicates that the motor control system is stable and does not lead to oscillations.

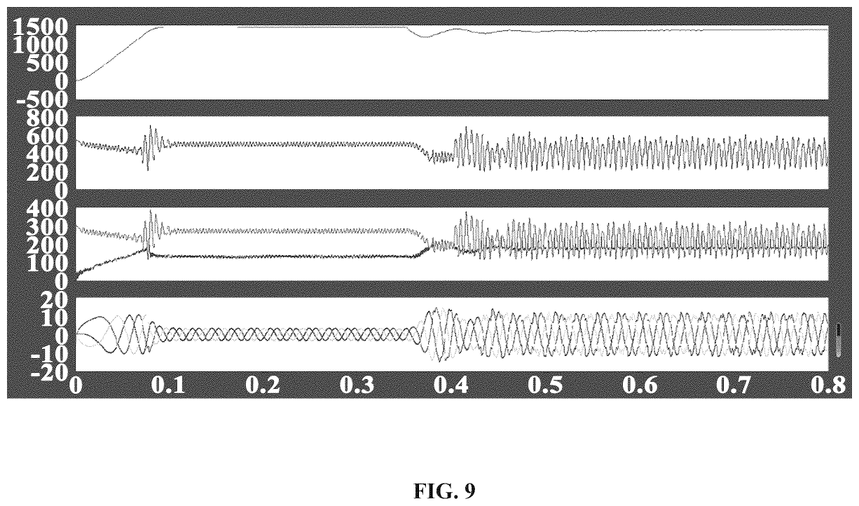

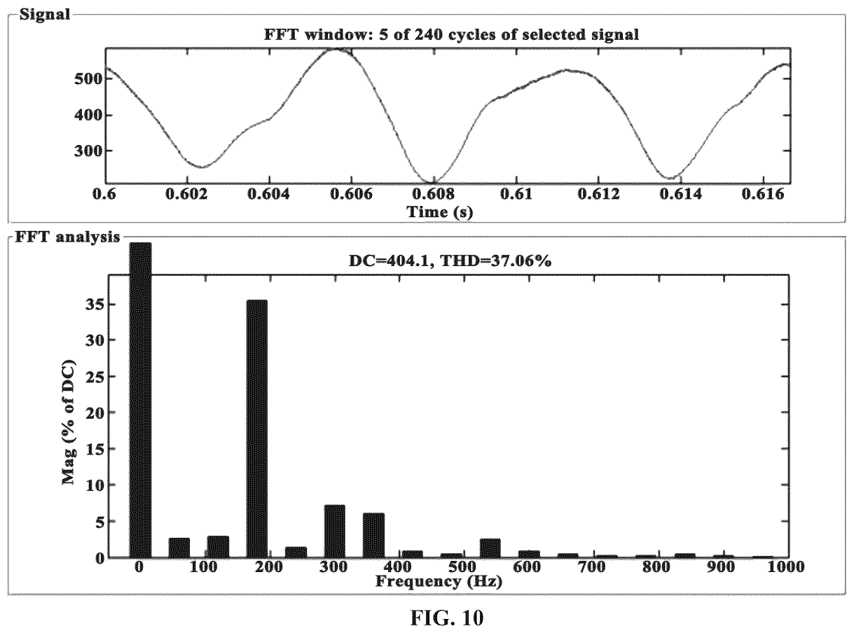

FIG. 9 illustrates the DC bus voltage fluctuations between 200 V and 600 V when the LC resonance suppression algorithm is not applied for the film capacitor. As shown in FIG. 10, the FFT analysis identifies two main harmonic components in the DC bus voltage: a 300 Hz rectification ripple and a 200 Hz LC resonance.

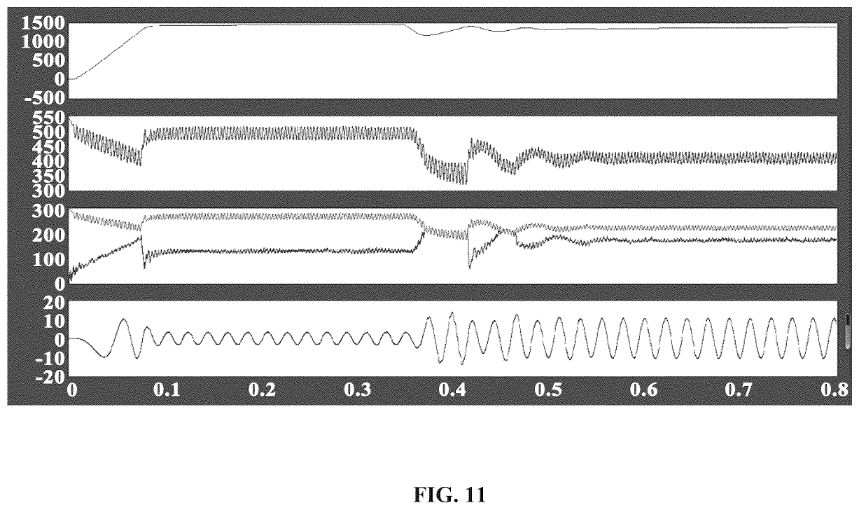

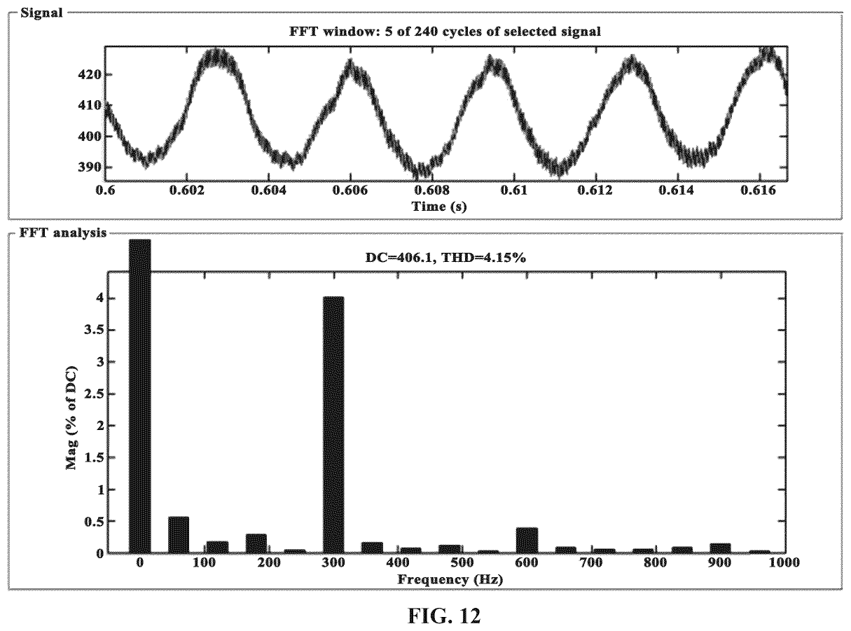

FIG. 11 illustrates the DC bus voltage fluctuations between 390 V and 430 V when the LC resonance suppression algorithm is applied for the film capacitor. As shown in FIG. 12, the FFT analysis confirms that although the 300 Hz rectification remains, the 200 Hz LC resonance is suppressed, thereby stabilizing the DC bus voltage.

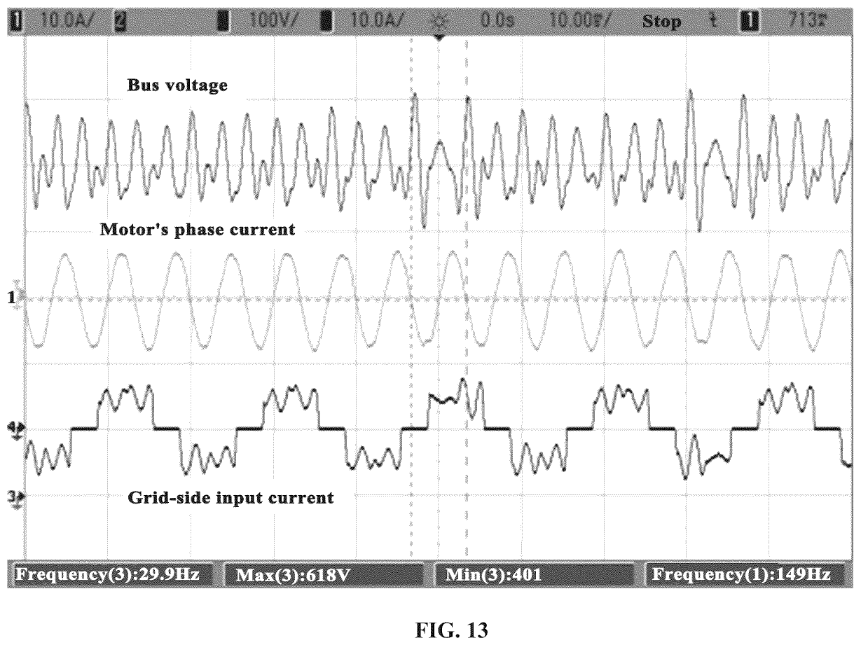

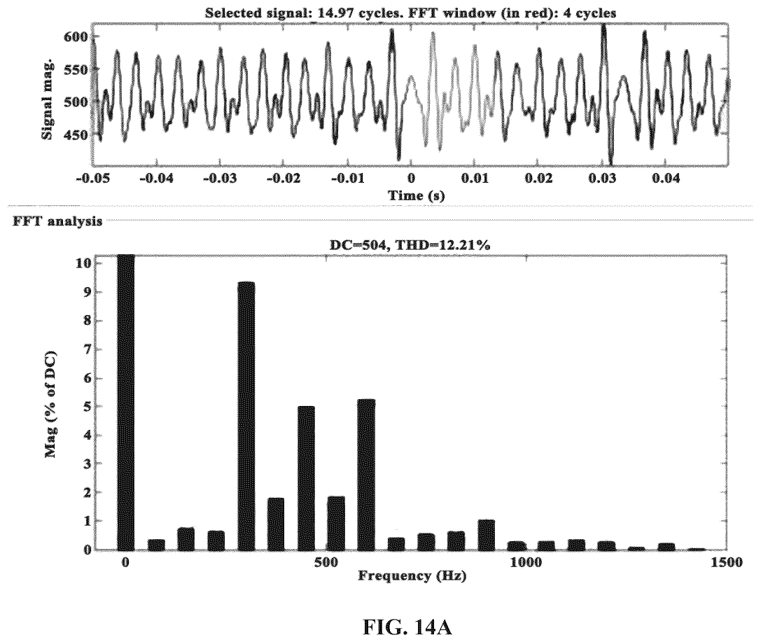

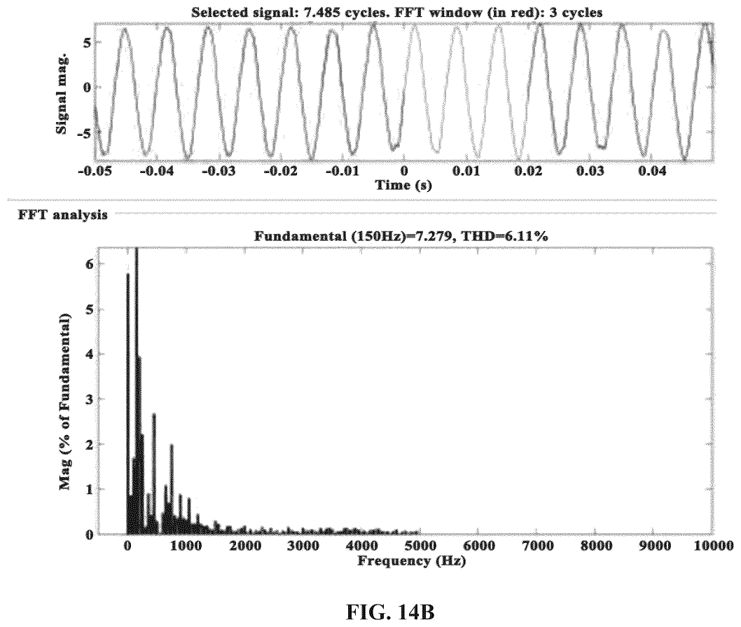

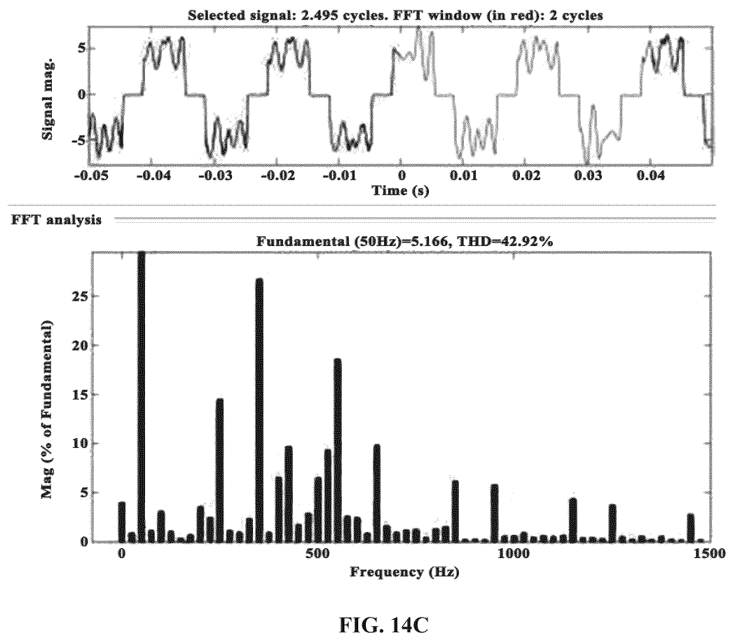

FIG. 13 shows the experimental comparisons of the motor performance without the LC resonance suppression, where the DC bus voltage fluctuates between 401 V and 618 V. As shown in FIGS. 14A-14C, the FFT analysis identifies harmonic distortion as follows: bus voltage THD: 12.21%, motor's phase current THD: 6.11%, and grid-side input current THD: 42.92%.

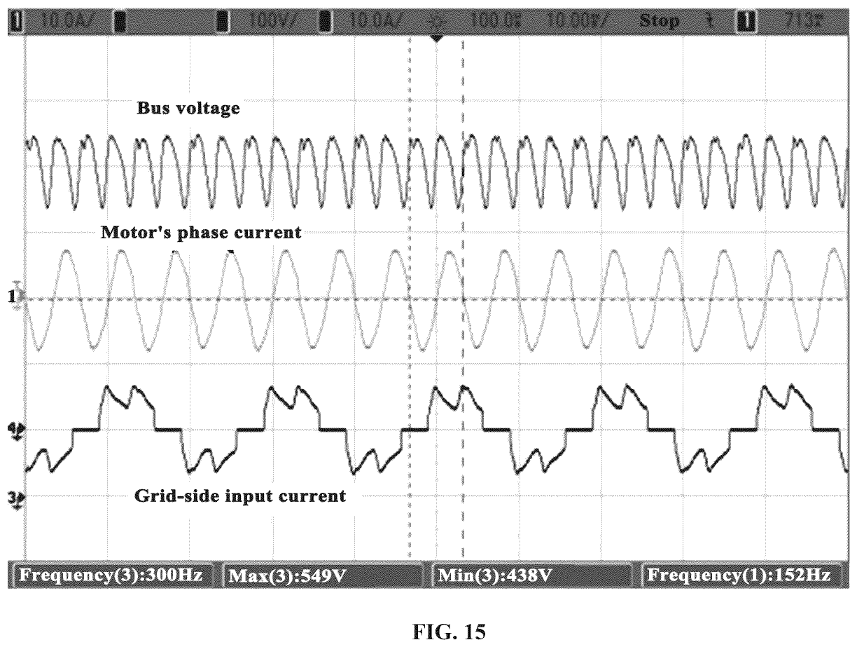

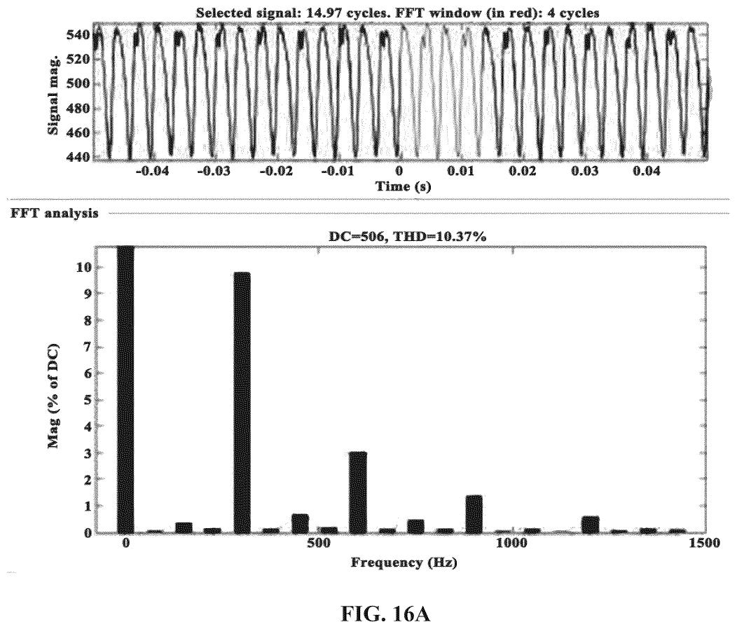

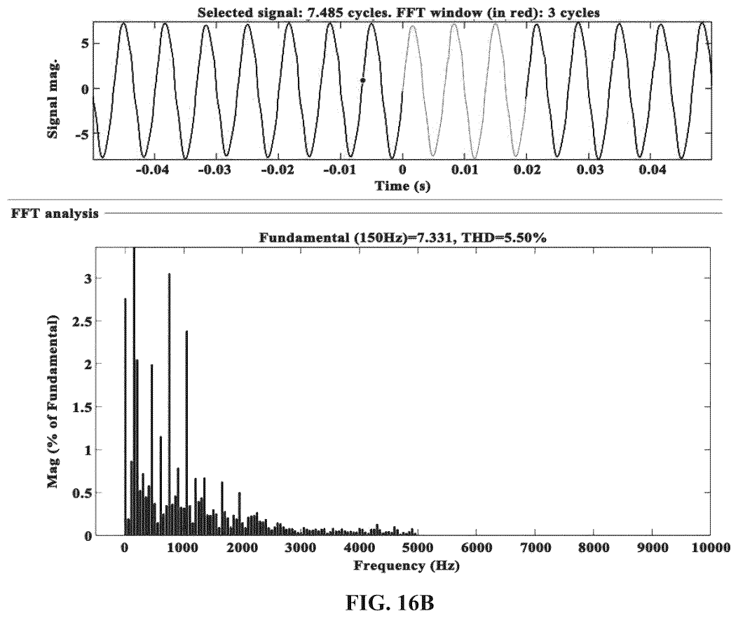

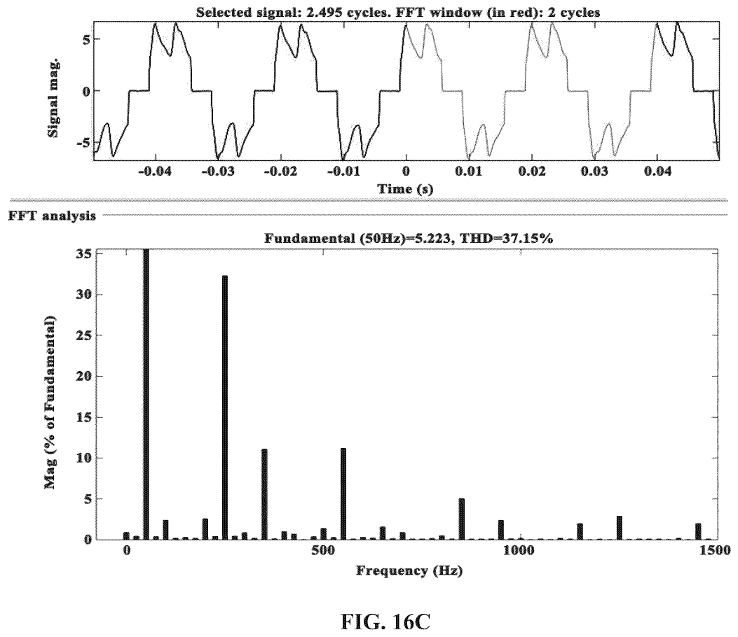

FIG. 15 shows the experimental comparisons of the motor performance with the LC resonance suppression, where the DC bus voltage variation narrows to 438 V to 549 V. As shown in FIGS. 16A-16C, the FFT analysis demonstrate a reduction in THD: bus voltage THD: reduced to 10.37%, motor's phase current THD: reduced to 5.5%, grid-side input current THD: reduced to 37.15%.

Data comparisons before and after implementing the LC resonance suppression algorithm show notable improvements in DC bus voltage stability and motor performance.

1. With the LC resonance suppression algorithm, the fluctuations on the DC bus voltage were significantly reduced, narrowing from a range of 401 V-618 V to 438 V-549 V.

2. Without the LC resonance suppression algorithm, the FFT analysis indicated both 300 Hz rectification and 400 Hz LC resonance. After applying the LC resonance suppression algorithm, the FFT analysis showed the 300 Hz rectification, confirming suppression of the LC resonance.

3. The LC resonance suppression algorithm reduced THD in both the motor's phase current and the grid-side input current, enhancing the performance and efficiency of the motor.

Here are the key technical terms and concepts:
The term “SVPWM”, also known as Space Vector Pulse Width Modulation, refers to a modulation technology that applies high-frequency carrier waves to an input signal, outputting high-frequency pulse signals to control the inverter switches;
The term “d-axis/q-axis”, as used herein, refers to axes in the reference frame of the motor, where the d-axis aligns with the motor's N-pole, while the q-axis is positioned 90 degrees ahead of the d-axis in term of electrical angle;
The term “PI Control”, also known as Proportional-Integral Control, refers to a control method that regulates the motor's current;
The term “Clarke Transformations”, as used herein, refers to mathematical conversions that convert a three-phase (ABC) system into two-phase (αβ) coordinates;
The term “Park Transformations”, as used herein, refers to mathematical conversions that convert a two-phase (αβ) coordinates into dq-coordinates;
U_{d} is the target voltage output for the d-axis, determined by a PI controller;
U_{q} is the target voltage output for the q-axis, determined by a PI controller;
U_{α} is the voltage on the a-axis, obtained by applying the inverse Park transformation (iPark) to the d-axis voltage and the q-axis voltage;
U_{β} is the voltage on the β-axis, obtained by applying the inverse Park transformation (iPark) to the d-axis voltage and the q-axis voltage;
Uₐ is the voltage across the A-phase winding of the motor, transformed from the dq-axis voltage using the iPark transformation;
U_{b} is the voltage across the B-phase winding of the motor;
Uᵥ is the voltage across the C-phase winding of the motor;
i_{d} is the feedback value of the current in the d-axis;
i_{q} is the feedback value of the current in the q-axis;
R_{dc} is the resistance associated with differential-mode inductance;
L_{dc} is the differential-mode inductance;
i_{g} is the current flowing through the differential-mode inductance;
uₛ is the source voltage in a simplified equivalent circuit;
u_{dc} is the sampled voltage across the DC bus;
C_{dc} is the capacitance value of the film capacitor;
iᵢₙᵥ is the average output current of the inverter;
P_{L} is the average power output of the inverter;
u_{dc0} is the DC component of the total DC bus voltage;
ũ_{dc} is the AC component of the total DC bus voltage;
s is the Laplace variable;
ū_{abc} is the vector form of the motor's phase voltages;
ī_{abc} is the vector form of the motor's phase currents;
u*_{dc} is the reference DC bus voltage;
q is a coefficient of the low-pass filter;
The term “THD”, also known as total harmonic distortion, refers to the ratio of the RMS value of the harmonic current to the RMS value of the fundamental current; and
The term “FFT”, also known as Fast Fourier Transform, refers to a frequency spectrum analyzer that converts a real-time domain signal into the frequency domain information, allowing for a detailed view of the frequency structure, amplitude, and phase.

It will be obvious to those skilled in the art that changes and modifications may be made, and therefore, the aim in the appended claims is to cover all such changes and modifications.

What is claimed is:

1. A method for reducing DC bus voltage fluctuations caused by a film capacitor in a permanent magnet synchronous motor, the permanent magnet synchronous motor adopting a (field-oriented control) FOC strategy; the method comprising:
S1. sampling, using a voltage sensing circuit, a total DC bus voltage (U_{dc}) from an inverter in real-time;
S2. passing the total DC bus voltage (U_{dc}) through a low-pass filter to extract a DC component (U_{dc0}) of the total DC bus voltage;
S3. obtaining an AC component (Tₑ=P₀·ψ_{f}×i_{q} - - - (1)) of the total DC bus voltage (U_{dc}) by subtracting the DC component (U_{dc0}) from the total DC bus voltage (U_{dc}): ũ_{dc}=U_{dc}−U_{dc0};
S4. obtaining a reference DC bus voltage (u*_{dc}) by subtracting the AC component (Tₑ=P₀·ψ_{f}×i_{q} - - - (1)) from the DC component (U_{dc0}): u*_{dc}=U_{dc0}−Tₑ=P₀·ψ_{f}×i_{q} - - - (1); and
S5. passing the reference DC bus voltage (u*_{dc}) to a space vector pulse width modulation (SVPWM) module, thereby performing calculations that generate precise switching signals for the inverter.

2. The method of claim 1, wherein the DC component (U_{dc0}) is calculated using the formula:
$${u}_{dc 0} ( n ) = {qu}_{dc} ( n ) + ( 1 - q ) {u}_{dc 0} ( n - 1 )$$
where, q is a coefficient of the low-pass filter; n is a number of times the voltage sensing circuit samples the total DC bus voltage (U_{dc}).

3. The method of claim 2, wherein a sampling frequency of the total bus voltage (U_{dc}) is in sync with a carrier frequency of the space vector pulse width modulation (SVPWM) module.
